(19) United States
(12) Patent Application Publication
(10) Pub. No.: US 2019/0322188 A1
(43) Pub. Date: Oct. 24, 2019

(54) SMART ELECTRIC VEHICLE PARKING AND CHARGING STATION

(71) Applicant: Y-Lectry, Inc., Palo Alto, CA (US)

(72) Inventor: Bruno Hermann Schrader, Palo Alto, CA (US)

(21) Appl. No.: 16/393,117

(22) Filed: Apr. 24, 2019

Related U.S. Application Data
(60) Provisional application No. 62/662,109, filed on Apr. 24, 2018.

(51) Int. Cl. B60L 53/30; B60L 58/13; B60L 53/16; B60L 53/51; B60L 53/62; B60L 53/66

(52) U.S. Cl. CPC B60L 53/305; B60L 58/13; B60L 53/665; B60L 53/51; B60L 53/62; B60L 53/16

(57) ABSTRACT

The present disclosure is directed to methods, apparatus, and systems that allow users to find charging stations and access those charging stations. Methods consistent with the present disclosure may allow a person to use a mobile device to register and provide information regarding their personal electric vehicles or batteries. A user may be allowed to charge their electric vehicle of a battery from an electric vehicle after they have provided payment or other information to a computing device. Apparatus consistent with the present disclosure may include a plurality of energize-able connectors at each of a plurality of parking spots located at a charging station one or more of which could be energized to charge a battery of an electric vehicle.

### CROSS REFERENCE TO RELATED APPLICATIONS

The present invention claims priority benefit of U.S. provisional application No. 62/662,109 filed on Apr. 24, 2018 entitled “Smart Electric Ridable Vehicle Parking and Charging Station” the disclosure of which is incorporated by reference.

### BACKGROUND OF THE INVENTION

### Field of Invention

The present invention generally relates to charging electric vehicles. More specifically, the present invention relates to charging different types of personal mobility electric devices using equipment that is accessible to the public.

### Description of the Related Art

With the development of improved energy storage/battery technologies, the market for ridable electric vehicles has increased dramatically in recent years. Currently there are many different types of rideable electrically powered vehicles are available, examples include scooters, skate boards, skates, bicycles, and chairs that are made by various different companies. Each different individual electric vehicle typically has a specific set of charging requirements. Even different scooters made by the same manufacturer may have different charging requirements. For example, a first scooter made by Company A may require a charging voltage of 24 volts (V) and a charging current of 3 amps (A) and a second scooter made by Company A may require a charging voltage of 36V and a current of 6 A. Furthermore each different electric vehicle may use a different type of physical electric interconnect or charging connector.

Individuals that own or use personal rideable vehicles often do not have a place where they can charge batteries in their rideable vehicle. This is especially true when those individuals are not near their home or when they are on vacation. Furthermore, individuals that would like to charge their rideable cannot find or identify where or how they can charge their rideable when they need to.

What are needed are new systems for methods for individuals to identify where they can charge their ridable in a manner that is consistent with a specific set of charging requirements according to the needs of those individuals.

### SUMMARY OF THE CLAIMED INVENTION

The presently claimed invention relates to a method, a non-transitory computer readable storage medium, or a system executing functions consistent with the present disclosure charging electronic devices. A method consistent with the present disclosure may receive device information, identify requirements to charge an energy storage element at the device, identify a charging location to connect the device to a connector at the charging location, and charge the energy storage element after a user device is connected to the connector at the charging location. The charging of the energy storage element may include energizing the connector at the charging location.

When a non-transitory computer readable medium implements a method consistent with the present disclosure, the method may also include receiving device information, identifying requirements to charge an energy storage element at the device, identifying a charging location to connect the device to a connector at the charging location, and charge the energy storage element after a user device is connected to the connector at the charging location. The charging of the energy storage element may include energizing the connector at the charging location.

A system of the present disclosure may include an interface that receives information associated with a device, an energize-able connector, a memory; and a processor that executes instructions out of the memory. As the processor executes instructions out of the memory the processor may identify requirements to charge an energy storage element at the device, identify a charging location to connect the device to the energize-able connector at the charging location, and charge the energy storage element after a user device is connected to the connector at the charging location. The charging of the energy storage element may include energizing the energize-able connector at the charging location.

### BRIEF DESCRIPTION OF THE DRAWINGS

FIG. 1 illustrates an exemplary charging station that may be associated with a personal computing device.

FIG. 2 illustrates a charging manager that communicates with numerous charging stations and with numerous different user devices.

FIG. 3 illustrates a computing system that may be used to implement an embodiment of the present invention.

FIG. 4A and FIG. 4B illustrate examples of content that may be displayed on a display at a user device.

FIG. 5 illustrates an exemplary charging station consistent with the present disclosure.

FIG. 6 illustrates an exemplary charging station consistent with the present disclosure that has several different electric vehicles locked into a respective parking stall or spot.

FIG. 7 illustrates a user device that may communicate with a charge management computer when a user approaches a charging kiosk.

### DETAILED DESCRIPTION

The present disclosure is directed to methods, apparatus, and systems that allow users to find charging stations and access those charging stations. Methods consistent with the present disclosure may allow a person to use a mobile device to register and provide information regarding their personal electric vehicles or energy storage devices/batteries that may have been removed from a personal electric vehicle. A user may be allowed to charge their electric vehicle or a battery from an electric vehicle after they have provided payment or other information to a computing device. Charging stations consistent with the present disclosure may include a plurality of different energize-able connectors of different types at various different parking spots or stalls of the charging station.

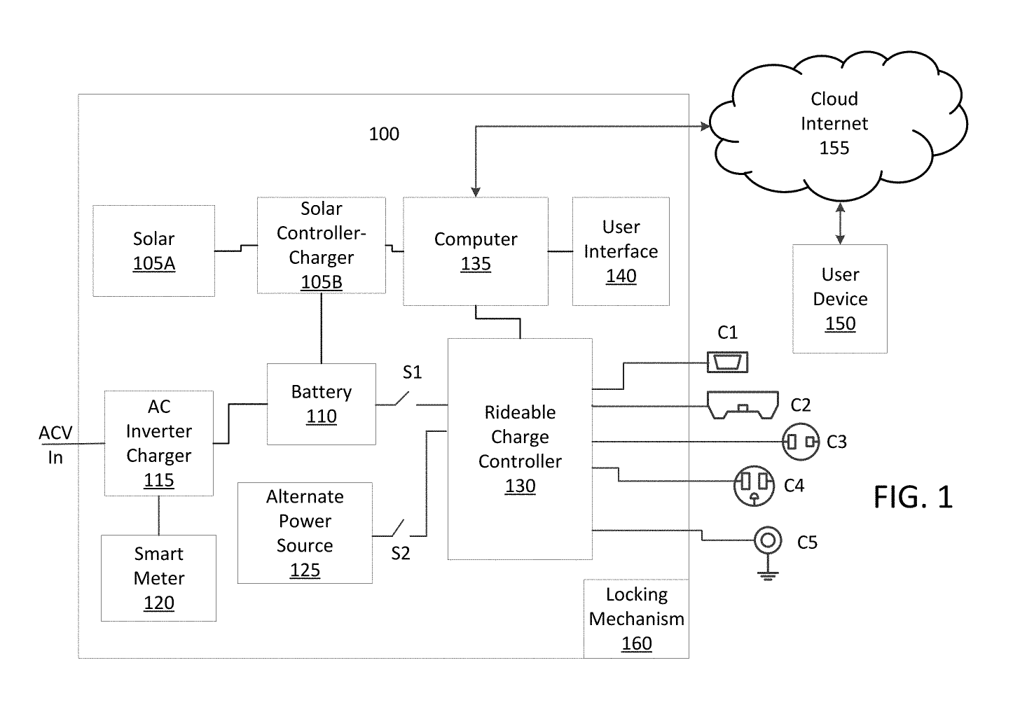

FIG. 1 illustrates an exemplary charging station that may be associated with a personal computing device. FIG. 1 includes charging station 100 that may be able to charge electrically powered vehicles in a manner that is consistent with a device's charging specifications. Charging station 100 includes solar panel 105A, solar charging controller 105B, energy storage device/battery 110, alternating current (AC) inverter/charger 115, smart meter 120, an alternate power source 125, rideable charge controller 130, computer 135, user interface 140, switches S1 & S2, and charging connectors C1, C2, C4, C4, & C5 (C1-C5). FIG. 1 also includes user device 150 and the cloud or Internet 155. Computer 135 may include a communication interface that sends and receives information via the cloud or Internet 155. Similarly, user device 150 may include a communication interface that communicates via the cloud or Internet 155.

Solar panel 105A may collect energy from the sun and solar charging controller 105B may use that collected energy to charge battery 110. Solar charging controller 105B may be coupled to computer 135, this coupling may allow computer 135 to receive communications from solar controller charger 105B. Alternatively or additionally, AC inverter charger 115 may receive power via a connection that provides an alternating current/voltage input ACV In and use energy from this power input to charge battery 110. While not illustrated in FIG. 1 charging station 110 may receive power via a direct current (DC) power source. FIG. 1 also includes locking mechanism 160 that may be used to lock an electric vehicle to a parking stall or spot of charging station 100.

Smart meter 120 may be used to monitor power received via an input. For example smart meter 120 may monitor how much power is received via input ACV In. Smart meter 120 may also send information to a power company that may charge a fee for the power received via input ACV In. Smart meter 120 may also be coupled to computer 135 so that computer 135 can also track or collect an amount of power received via input ACV In. In certain instances the power used to charge battery 110 may be switched between a solar power based charging apparatus to an AC or DC power input/charging apparatus.

Alternate power source 125 may be any type of power source including, yet not limited to a second battery, a hydrogen fuel cell, a natural gas fuel cell, a wind power generator, or an energy harvesting device. Note that a first switch S1 may be used to selectively connect battery 110 to rideable charge controller 130. Note also that a second switch S2 may be used to selectively connect alternate power source 125 to rideable charge controller 130. Switches S1 and S2 may be implemented using mechanical or electrical relays, or may be switched using transistors or field-effect transistors (FET switches).

The rideable charge controller 130 of FIG. 1 has five different charging outputs C1, C2, C3, C4, & C5 (C1-C5). In certain instances charging station 100 may include multiple charging controllers like charge controller 130 where each charge controller may be used to charge one or more electric vehicles. In other instances charging station 100 may include a single rideable charge controller that includes multiple ports that may be used to charge numerous different electric vehicles. Each of these multiple ports may include numerous different charging connectors like connectors C1-C5.

The various different types of control electronics illustrated in FIG. 1 may be implemented within a single electronic controller or be implemented with numerous different separate devices or printed circuit boards. As such, computer 135, solar controller charger 105B, and rideable charge controller 130 may be contained within one or more physical devices. In certain instances, charging station 100 may include fewer or more different power inputs. For example, some charging stations may not include a solar panel or a solar charging controller, where others may not include an AC power input and associated electronics. In another example, charging station 100 may include a DC power input or an input powered by the wind.

Charging connectors C1-C5 may be included in a single cable that is coupled to a port of charging station 100. In such instances, only one connector may be energized when a particular type of electric vehicle is charged. For example, charging connector C1 may be energized when charging Model A of Company B's electric skateboard and connectors C2-C5 may not be energized. As such, electrical connections to connectors C1-C5 may be controlled using mechanical or electrical relays or may be switched using transistors of field effect transistors (FET switches). Charging connectors C1-C5 may also be configured to transport power via transformer action using magnetic induction (via coils of wire), in such instances an AC voltage may be applied to connector C1, for example, and power could be transferred to charge a battery at an electric vehicle through a compatible inductive connector (coil of wire) at the electric vehicle.

Computer 135 may also digitally communicate with rideable charge controller 130 or may monitor analog inputs/outputs of the rideable charge controller. As such, computer 135 may monitor how much power is being supplied to an electric vehicle/battery and may monitor the charging of a battery in an electric vehicle when identifying whether that vehicles battery is being safely charged. In instances where a current above a threshold amount is being supplied via a connector, computer 135 may identify battery fault condition. Alternatively or additionally rideable charge controller may include fuses, circuit breakers, or transitory circuit breakers. In such instances circuit breakers may be reset automatically via computer 135 or via control electronics within rideable charge controller 130. In other instances transitory circuit breakers may automatically close after a fault condition has been observed. In instances when circuit breakers are reset and repetitively trip (open up) a port or connector of charging system 100 may be de-energized (turned off).

In instances when a battery of an electric vehicle appears to be failing, computer 135 may send a message via the cloud or internet 155 to user device 150 informing the owner of that vehicle of the apparent failure. Alternatively or additionally messages sent to user device 150 may be sent via a cellular phone network, telephone line, or other communication network.

Charging station 100 may include multiple slots, where each of those slots may include on or more charging connectors. A locking mechanism may be coupled to each slot and that locking mechanism may be used to physically lock an electric vehicle to charging station 100.

User interface 140 may be used by a user to enter information regarding their electric vehicle. That user may identify a model number of a scooter, for example, and provide payment information. The user interface 140 may then inform that user of which slot or which connector at charging station 100 that they should use to charge their vehicle. Individuals may be charged a monetary sum based on how long their vehicle is connected to a slot at charging station 100, may be charged the monetary sum for how much energy is used to charge their vehicle, or may be charged the monetary sum according to a criteria established by an administrator.

Alternatively or additionally, charging station 100 may receive a battery. In such instances that battery may have been removed from an electric vehicle, such batteries may also be locked to or be locked in a locker (or slot) at charging station 100. Such a charging system would allow owners of electric vehicles to keep possession of their vehicle as their battery charges and to charge one battery while they use another.

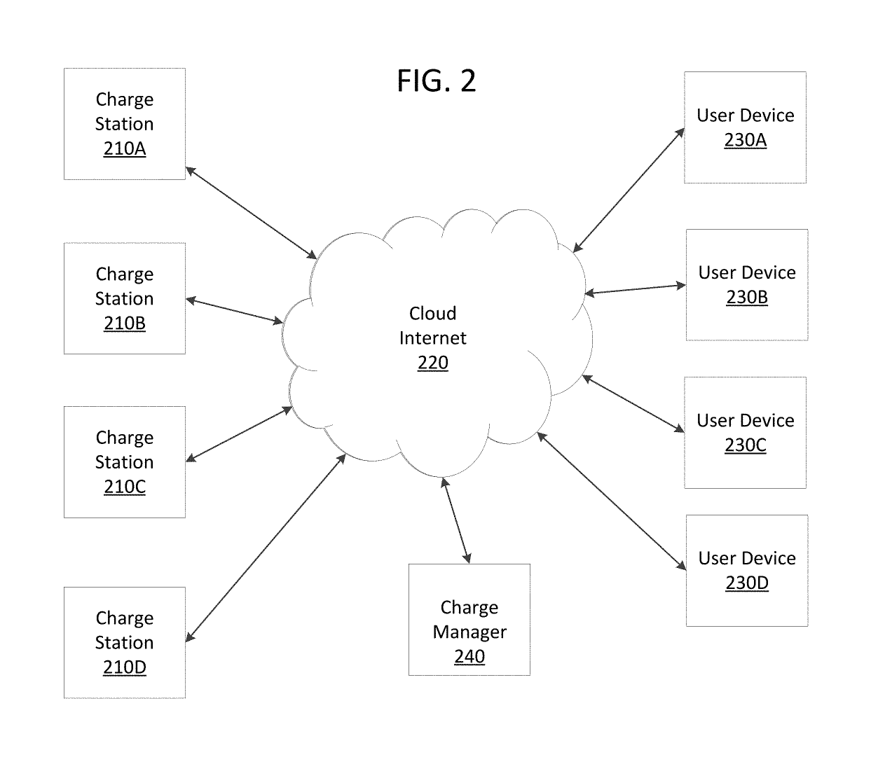

FIG. 2 illustrates a charging manager that communicates with numerous charging stations and with numerous different user devices. FIG. 2 includes charging stations 210A, 210B, 210C, 210C, and 210D (210A-210D). FIG. 2 also includes cloud or Internet 220, charge manager 240, and user devices 230A, 230B, 230C, 230C, and 230D (230A-230D).

Charge manager 240 may be a server or computer located in the cloud or internet 220. Charge manager 240 may receive information from user devices 230A-230D or send communications to one or more of these user devices. Information received from these user devices may include registration information, information that identifies charging requirements, information that identifies a model number/manufacturer of an electric vehicle, or that identifies a type of energy storage device/battery. Charge manager 240 may also provide information regarding locations where a charging station is physically located. Charge manager 240 may also receive location information from a user device when identifying a charging station closest to a particular location. Location information received by charge manager 240 may be identified by a global positioning system at a user device, may be an address entered by a user of a user device, or may be based on other information (cross streets, the name of a park, or the name of an attraction). Charge manager may also provide mapping information to a user device that shows where a charging station is located.

Charge manager 240 may also communicate with charge stations 210A-210D. Here charge manager 240 may provide user device information to a particular charging station that a user will use based on communications received by the charge manager from a user device. Charge manager 240 may also receive information relating to how much energy was used charging a device, may receive an amount of time that a user used a slot at a charging station, or may receive information that identifies a user of an event. Events that a user may be notified of include an indication that their vehicle or battery may be failing, or such notifications may inform a user that their vehicle or battery is fully charged. Alternatively or additionally a particular charging station may communicate directly with a user device using any communication technology supported by a user device. For example, these communications may be sent over a cellular (3G/4G) network, may be sent by other communication networks such as 802.11 Wi-Fi network, or may communicate using Bluetooth communications.

In certain instances, a user device may communicate with a charging station and with a charge manager. In such instances, additional security may be provided by a charging station communicating with a user device using short range wireless communication connections like Bluetooth™, Near Field communication (NFC) technology, by using another form communication interface (such as a SiBeam Snap or Keyssa Kiss connector), or by using optical or infrared communications.

Communications between a user device and charging station or with a charge manager may also be used to acknowledge that the user is ready to remove a device/vehicle from the charging stations when they are ready to take back possession of their device/vehicle.

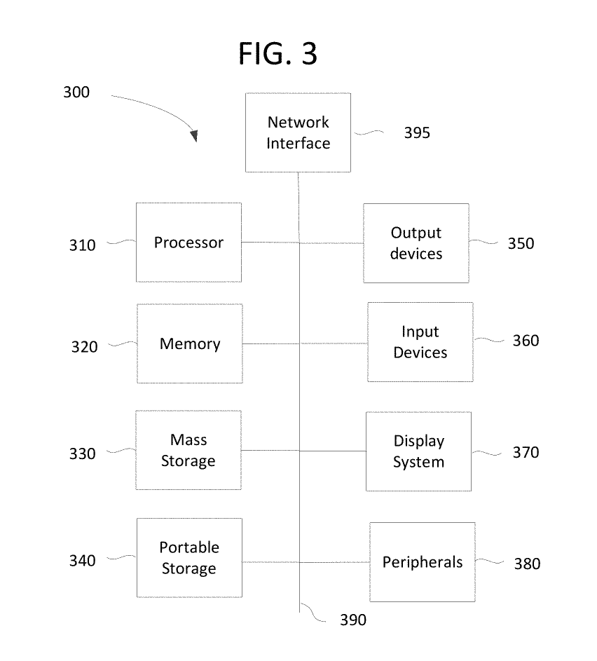

FIG. 3 illustrates a computing system that may be used to implement an embodiment of the present invention. The computing system 300 of FIG. 3 includes one or more processors 310 and main memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, peripheral devices 380, and network interface 395. The components shown in FIG. 3 are depicted as being connected via a single bus 390. However, the components may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320. Portable storage device 340 operates in conjunction with a portable non-volatile storage medium, such as a FLASH memory, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors. Display system 370 may include a liquid crystal display (LCD), a plasma display, an organic light-emitting diode (OLED) display, an electronic ink display, a projector-based display, a holographic display, or another suitable display device. Display system 370 receives textual and graphical information, and processes the information for output to the display device. The display system 370 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 380 may include any type of computer support device to add additional functionality to the computer system. For example, peripheral device(s) 380 may include a modem or a router. Network interface 395 may include any form of computer interface of a computer, whether that be a wired network or a wireless interface. As such, network interface 395 may be an Ethernet network interface, a BlueTooth™ wireless interface, an 802.11 interface, or a cellular phone interface.

The components contained in the computer system 300 of FIG. 3 may include components typically found in computer systems that may be suitable for use with embodiments of the present invention and are intended to represent a broad category of such computer components that are well known in the art. Thus, the computer system 300 of FIG. 3 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 300 may in some cases be a virtual computer system executed by another computer system. Various operating systems can be used including Unix, Linux, Windows, Macintosh OS, Palm OS, Android, iOS, and other suitable operating systems.

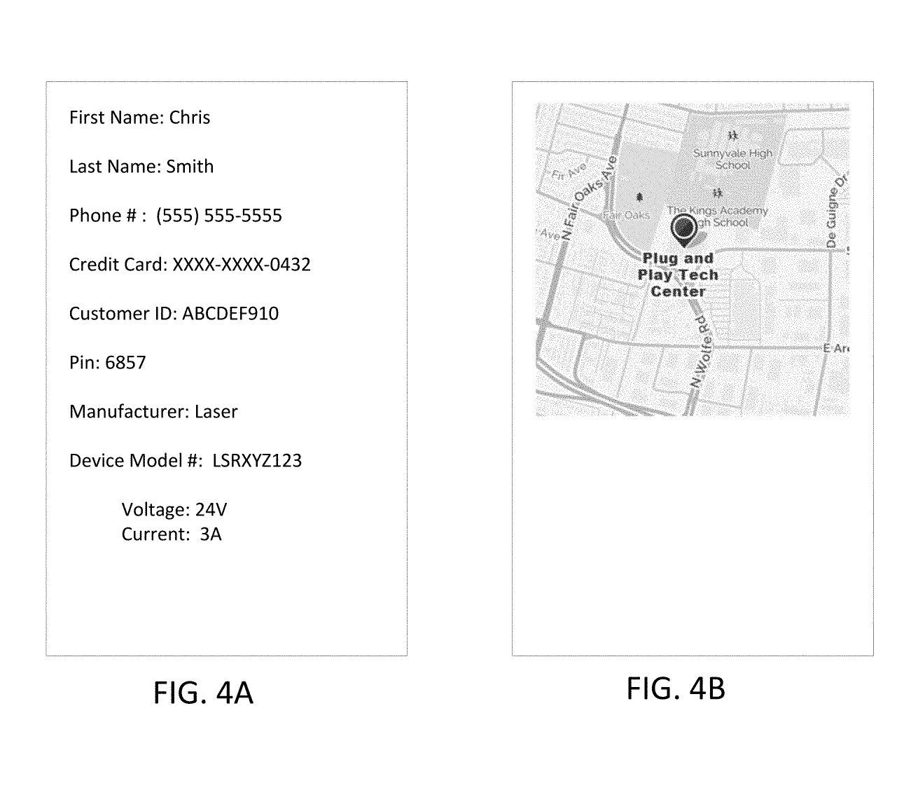

FIG. 4A and FIG. 4B illustrate examples of content that may be displayed on a display at a user device. FIG. 4A illustrates an exemplary set of registration information that may be entered into a user interface of a use device. FIG. 4A identified a first name of Chris, a last name of Smith, a phone number 555-555-5555, a credit card number of XXXX-XXXX-0432, a customer ID number of AFCCDEF910, a pin 9857, a manufacturer of Laser, a device model number of LASRXYZ123, a charging voltage of 24 volts (V), and a charging current of 3 amps (A). The user of the user device may also select a pin number that can be used to verify a user of the user device when that user wishes to charge an electric vehicle. Alternatively or additionally biometric information may be used to verify the identity of a user.

The information included in the user interface of FIG. 4A may be entered by a user or be entered automatically after a user device received and identified words spoken by a user. The manufacturer and model number may also have been identified after a user takes a photograph or scan of information included in an identifier mounted on an electric vehicle or on a battery that a user wishes to charge. The identifier may include text, numbers, be a bar code, be a computer readable quick response (QR) code, or be a near field communication (NFC) chip that sends information via a radio signal. Application software code at a user device or software at another computer may receive the photographed or scanned information. This information may then be used to identify a vehicle owned by the user and to identify associated charging information. For example, a user may photograph an identifier at an electric vehicle, that photograph may be sent to a computer (such as a charge manager computer or a computer at a charging station), after which the computer may sent information back to the user device. The user device may then display the manufacturer, the model number, the charging voltage, and the charging current on the display of the user device. After all of this information has been identified, a user may create an account that can be accessed when a user wishes to charge an electric vehicle.

In instances where a particular user owns several different types of electronic vehicles or similar vehicles with different charging requirements, that user may register each different vehicle with a charge management computer consistent with the present disclosure. When a user wishes to charge a vehicle, a user device may send a communication to a charge manager. The charge manager may coordinate with a charging station when a user connects their electric vehicle to a connector at a charging station. In such an instance account or other information may be provided to the charge manager and the charge manager may allow the charging station to charge an electric vehicle of the user.

Alternatively or additionally, a user device may communicate account information with a charging station and the charging station may communicate with a charge manager such that the charge manager may identify the user, receive information from the charging station that can be used to receive payment from a user's credit card, for example. Here again the user may be charged for services rendered by the charging station, where those charges may be paid by a credit card, by Pay Pal, or by some other payment service.

FIG. 4B illustrates a map that identifies a location where a charging station of the present disclosure is located. The mapped location of Plug and Play may have been provided to a user device because it is close to a location where the user device is presently located. The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

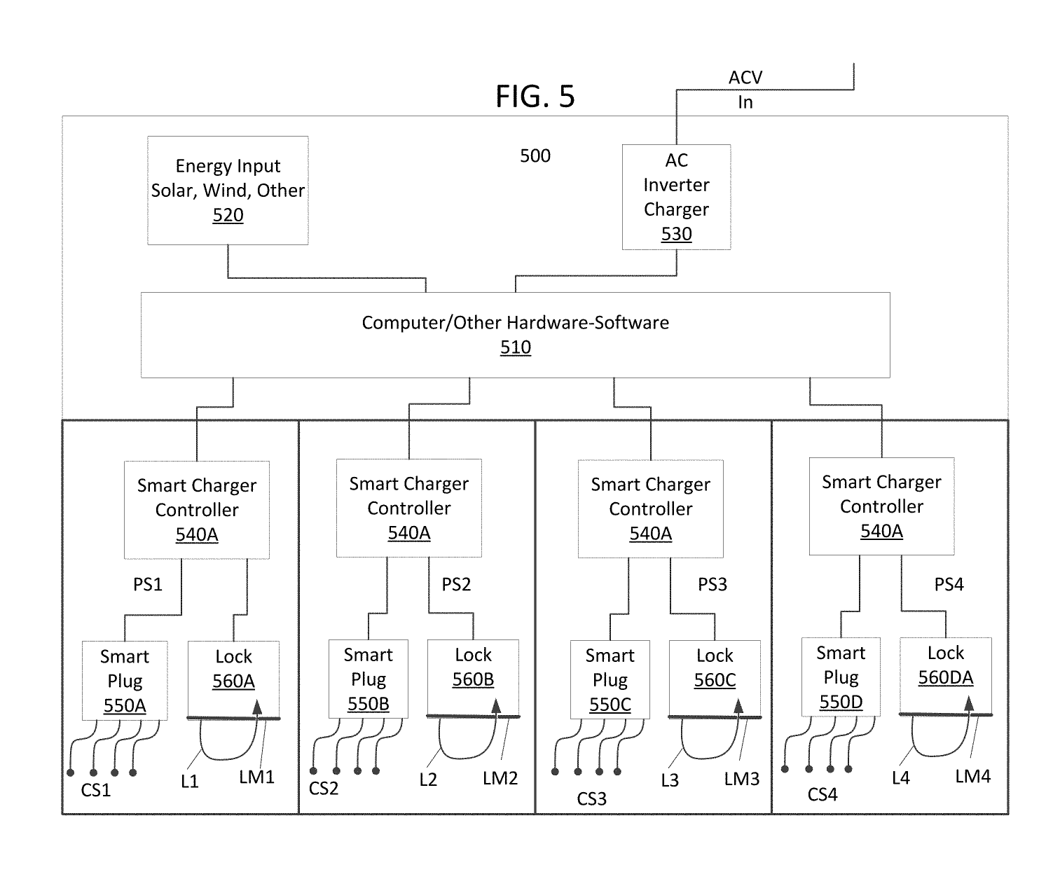

FIG. 5 illustrates an exemplary charging station consistent with the present disclosure. Charging station 500 illustrated in FIG. 5 includes a computer/other hardware-software 510, an energy source 520, an ACV In power input, an AC inverter charger 530, and four different parking stalls (PS1, PS2, PS3, and PS4). Each of the different parking stalls include a smart charging controller (540A, 540B, 540C, and 540D), a smart plugs (550A, 550B, 550C, and 550D), and a lock (560A, 560B, 560C, 560D). Note that smart plug 550A of PS1 includes a first connector set CS1, smart plug 550B of PS2 includes a second connector set CS2, smart plug 550C of PS3 includes a third connector set CS3, and that smart plug 550D of PS4 includes a third connector set CS3. Note also that PS1 includes a first lock 560A, a latch L1, and locking mechanism LM1; PS2 includes a second lock 560A, a second latch L2, and locking mechanism LM2; PS3 includes a third lock 560A, a third latch L3, and locking mechanism LM3; PS4 includes a fourth lock 560A, a fourth latch L4, and locking mechanism LM4.

Like the charging connectors of FIG. 1, each parking stall (PS1, PS2, PS3, and PS4) may include multiple different charging connectors that form respective connector set (CS1, CS2, CS3, and CS4), respective locks (560A, 560B, 560C, 560D), respective latches (L1, L2, L3, and L4), and respective locking mechanisms (LM1, LM2, LM3, and LM4). Each respective latch (L1, L2, L3, and L4) may include a cable or a bar that engages a respective latching mechanism (LM1, LM2, LM3, and LM4) that may retain a physical feature associated with a rideable vehicle, including yet not limited to a wheel, a frame, or a handle bar of a respective rideable vehicle.

Note that energy source 520 may include any form of additional source, such as a solar panel, a wind turbine, or other source. In certain instances renewable energy sources may be preferred. As with the charging station of FIG. 1, charging station 500 may also include an AC power input from a power line ACV In that is coupled to computer/other hardware-software 510 via an AC inverter charger 530. Inverter charger 530 may convert an AC voltage into a DC voltage that is used to charge a battery that may be associated with the computer/other hardware-software 510 of FIG. 5.

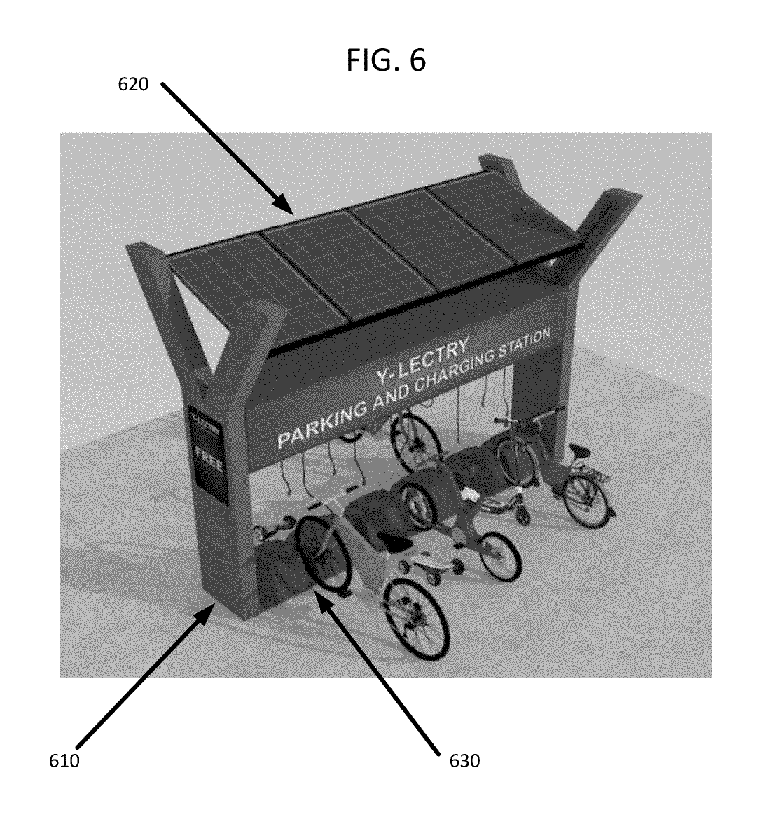

FIG. 6 illustrates an exemplary charging station consistent with the present disclosure that has several different electric vehicles locked into a respective parking stall or spot. FIG. 6 includes charging station 610, solar panels 620 that may provide energy for charging a battery at charging station 610, and locking mechanism 630 that locks a first electric bicycle to charging station 610.

Charging stations consistent with the present disclosure may also include one or more of a display that provides advertisements, a coupon dispenser, coupons that are distributed electronically directly to a mobile device via a wireless transmission, a crypto-currency payment means, or a 802.11 compatible Wi-Fi access point, a cell phone charger. In certain instances a display associated with the charging station may also be used to display public information, such as the local time, a current temperature, ultra-violet levels, or weather information).

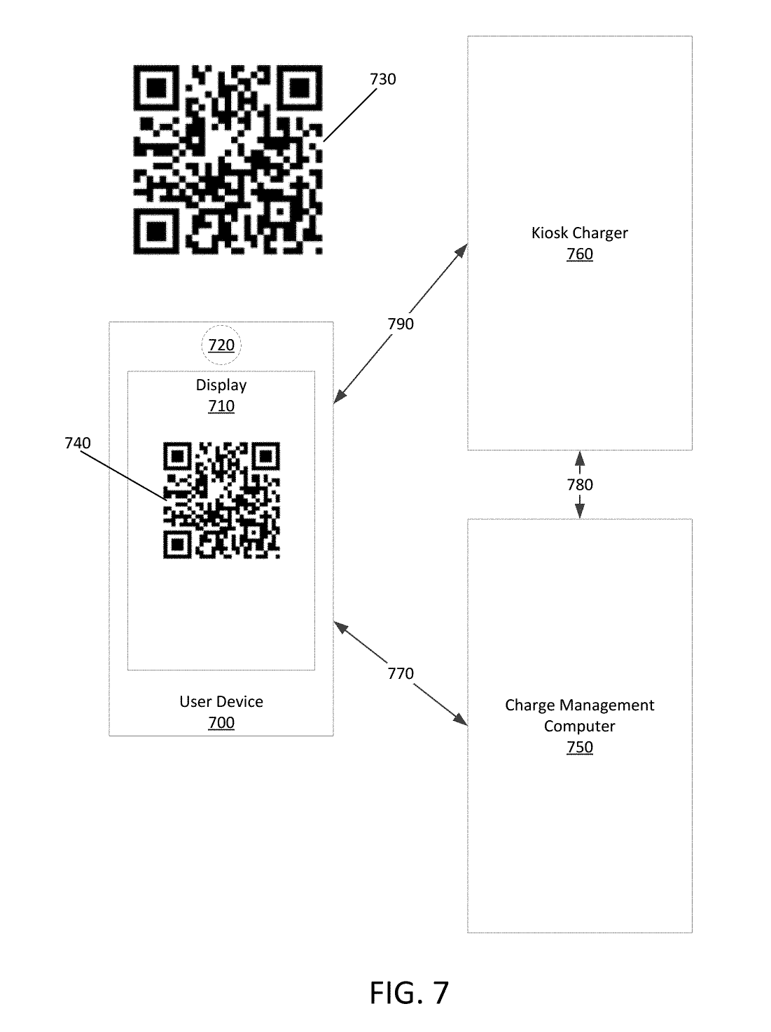

FIG. 7 illustrates a user device that may communicate with a charge management computer when a user approaches a charging kiosk. FIG. 7 includes user device 700, quick response (QR) code 730, charge management computer 750, and kiosk charger 760. Each charging stall or spot at a charging station like charging station 610 of FIG. 6 may be identified by a scan-able item like the QR code 740 of FIG. 7. User device includes display 710 and camera 720, where camera 720 may be used to capture an image of QR code 730 that may be displayed on display 710 as item 740 of FIG. 7.

When the user approaches a stall or parking spot at a charging station, they may scan an image of QR code 730 using camera 720 of user device 700. After user device 700 scans the image of QR code 730, display 710 of user device 700 may display the scanned QR code 730 as item 740 in display 720. QR code 740 may be used to uniquely identify a particular stall at a particular charging station. After QR code 730 is scanned by user device 700, user device 700 may communicate with charge management computer 750. In certain instances charge management computer 750 may be a computer that resides in the cloud or Internet. Alternatively charge management computer 750 may reside at a charging station such as a computer 135 at charging station 100 of FIG. 1.

The scanning of QR code 740 by user device 710 may also cause user device 710 to communicatively connect with the charge management computer 750 when preparing to charge an electric ridable vehicle. Communications 770 between user device 700 and charge management computer 750 may be sent over a cellular communication network or may be communicate to charge management computer 750 using other wireless communication technologies, such as Bluetooth or 802.11 (WI-FI). Charge management computer 750 may then communication with kiosk charger 760 using communication 780 of FIG. 7. Communications 790 may then be sent to user device 700 as the user of user device 700 connects their ridable electric vehicle to a charging connector, such as any of charging connectors C1 through C5 of FIG. 1. This process may also include locking the electric vehicle of the user to the charging kiosk stall identified by QR code 730.

Program code associated with a program application executed by a processor at user device 700 may decode information encoded into QR code 730 and this program application may be configured to transmit information decoded from QR code 730 to charge management computer 750. Information sent to charge management computer 750 may include information that identifies a stall or parking spot at a charging station where the user wishes to use to charge a battery that powers their electric vehicle. The information sent to charge management computer 750 may also identify a specific charging station that is also identified by information included in QR code 730. QR code 730 may also include information that identifies a communication pathway that should be used by user device 700 to send information to charge management computer 750. Alternatively user device 700 may send an image 740 of QR code 730 to charge management computer 750 and charge management computer 750 may decode relevant information from the received image data.

Information stored at user device 700 or at charge management computer 750 may be used to identify a type of electrical vehicle that the user wishes to charge. The type of electrical vehicle may be identified by accessing user registration information that identifies the type of electric vehicle. Alternatively the type of electric vehicle may be identified after use device 700 captures an image and sends that image to charge management computer 750. Electrical vehicle image data sent to charge management computer 750 may be an image of the electric vehicle or may be an image of a label located on the electrical vehicle that can be uses to identify a make and model of the electric vehicle. After the relevant information has been provided to charge management computer 750, a user of user device 700 may be allowed to charge a battery of their electrical vehicle at the charging location identified in bar code 730.

While FIG. 7 includes a QR code that identifies a charging stall or parking spot at a charging station, methods consistent with the present disclosure may user other forms of scan-able items that can be used to identify a charging stall and possibly a particular charging station or kiosk. These other forms of scan-able items may include text, a bar code, or a near field communication (NFC) tag or chip. Charge management computer 750 of FIG. 7 may perform functions consistent with charge manager 240 of FIG. 2 and user device 700 may perform functions consistent with user devices 230A-230D of FIG. 2.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for electrically charging devices, the method comprising:
receiving information associated with a device,
identifying charging requirements associated with an energy storage element at the device;
identifying a charging location to connect a connector of one or more connectors to the device, wherein the charging location is associated with the one or more connectors for charging electrically powered devices and the device is attached to a first connector of the one or more connectors based on the first connector being compatible with the device; and
energizing the first connector, wherein the energy storage element at the device is charged after the device is connected to the first connector.

2. The method of claim 1, further comprising monitoring an amount of electrical power used to charge the energy storage element at the device.

3. The method of claim 1, further comprising monitoring an amount of time that the device resides at the location.

4. The method of claim 1, further comprising identifying that the energy storage element at the device is fully charged.

5. The method of claim 4, further comprising sending a message to a user device that identifies that the energy storage element at the device is charged.

6. The method of claim 1, further comprising receiving information that identifies the charging location.

7. The method of claim 1, wherein the charging location information was identified after a user device scanned a scan-able item based on the scan-able item cross referencing the charging location with a charging stall and the method further comprising identifying that a lock has been engaged that secures that device.

8. A non-transitory computer readable medium having embodied thereon a program executable by a processor to implement a method for electrically charging devices, the method comprising:
receiving information associated with a device,
identifying charging requirements associated with an energy storage element at the device;
identifying a charging location to connect a connector of one or more connectors to the device, wherein the charging location is associated with the one or more connectors for charging electrically powered devices and the device is attached to a first connector of the one or more connectors based on the first connector being compatible with the device; and
energizing the first connector, wherein the energy storage element at the device is charged after the device is connected to the first connector.

9. The non-transitory computer readable medium of claim 8, the program further executable to monitor an amount of electrical power used to charge the energy storage element at the device.

10. The non-transitory computer readable medium of claim 8, the program further executable to monitor an amount of time that the device resides at the location.

11. The non-transitory computer readable medium of claim 8, the program further executable to identify that the energy storage element at the device is fully charged.

12. The non-transitory computer readable medium of claim 11, the program further executable to send a message to a user device that identifies that the energy storage element at the device is charged.

13. The non-transitory computer readable medium of claim 8, the program further executable to receive information that identifies the charging location.

14. The non-transitory computer readable medium of claim 8, wherein the charging location information was identified after a user device scanned a scan-able item based on the scan-able item cross referencing the charging location with a charging stall and the method further comprising identifying that a lock has been engaged that secures that device.

15. An system for electrically charging devices, the apparatus including:
an interface that receives information associated with a device;
one or more energize-able connectors
a memory; and
a processor that executes instructions out of the memory to:
identify charging requirements associated with an energy storage element at the device,
identify a charging location to connect a connector of one or more connectors to the device, wherein the charging location is associated with the one or more energize-able connectors for charging electrically powered devices and the device is attached to a first connector of the one or more energize-able connectors based on the first connector being compatible with the device, and
energize the first connector, wherein the energy storage element at the device is charged after the device is connected to the first connector.

16. The system of claim 15, further comprising a charge management computer that is physically remote from the processor and the memory that is communicatively coupled to the process via the interface.

17. The system of claim 15, further comprising a primary power source and a secondary power source.

18. The system of claim 15, further comprising a meter that measures an amount of electrical power provided to charge the device.

19. The system of claim 15, further comprising a locking mechanism that secures the device.

20. The system of claim 15, further comprising a user interface that receives information from a user and that displays information that identifies the charging location.
